(19) United States
(12) Patent Application Publication
(10) Pub. No.: US 2011/0237719 A1
(43) Pub. Date: Sep. 29, 2011

(54) PARTICLE, RESIN COMPOSITION AND RESIN MOLDED ARTICLE

(75) Inventors: Sayaka INOUE, Kanagawa (JP); Masahiro Moriyama, Kanagawa (JP); Masaya Ikuno, Kanagawa (JP); Masato Mikami, Kanagawa (JP); Masayuki Okoshi, Kanagawa (JP); Kenji Yao, Kanagawa (JP)

(73) Assignee: FUJI XEROX CO., LTD., TOKYO (JP)

(21) Appl. No.: 12/868,275

(22) Filed: Aug. 25, 2010

(30) Foreign Application Priority Data
Mar. 24, 2010 (JP) 2010-068908

(51) Int. Cl. C08K 5/521

(52) U.S. Cl. 524/127

(57) ABSTRACT

A particle including: at least one selected from an ionic liquid that has, as an organic cation, one selected from cyclic amidine ion-based organic cations, pyridinium-based organic cations, ammonium-based organic cations, sulfonium-based organic cations, and phosphonium-based organic cations, or a liquid phosphate ester; and a polymer compound that serves as a base material, a resin composition including the particle and a resin molded article including the resin composition are provided.

### CROSS-REFERENCE

This application is based on and claims priority under 35 USC 119 from Japanese Patent Application No. 2010-068908 on Mar. 24, 2010.

### BACKGROUND

### Technical Field

The present invention relates to a particle, a resin composition and a resin molded article.

### SUMMARY

According to an aspect of the invention, there is provided a particle comprising: at least one selected from an ionic liquid that has, as an organic cation, one selected from cyclic amidine ion-based organic cations, pyridinium-based organic cations, ammonium-based organic cations, sulfonium-based organic cations, and phosphonium-based organic cations, or a liquid phosphate ester; and a polymer compound that serves as a base material.

### BRIEF DESCRIPTION ON THE DRAWINGS

Exemplary embodiment of the present invention will be described in detail based on the following FIGURE, wherein:

FIG. 1 is a diagram illustrating an example of a component of electric and electronic apparatus having a resin molded article according to the present exemplary embodiment.

### DETAILED DESCRIPTION

Hereinafter, a preferred exemplary embodiment of the particle, the resin composition and the resin molded article of the present invention is described.

### <Particle>

A particle of the present exemplary embodiment is characterized in that a polymer compound that serves as a base material (hereinafter, it referred to simply as ‘base polymer’) is combined with at least one selected from a liquid phosphate ester or an ionic liquid (hereinafter, both are referred as “liquid flame retardant”).

A liquid phosphate ester or an ionic liquid (liquid flame retardant) is a compound which gives a flame retardant property to a resin molded article by being contained in a resin molded article, and it also has a plasticity effect for the resin which is used in a molding of resin molded article (commonly called a matrix resin). Further, a polymer compound that serves as a base material (base polymer), especially base polymer in which the glass transition temperature (Tg) is room temperature (25° C.) or less, or a polymer compound (base polymer) dispersing polymer compound which has high compatibility with a low molecular compound, an oligomer compound or a base polymer compound gives an impact resistance to a resin molded article by being contained in a resin molded article.

When the particle of the present exemplary embodiment is added to a resin, the compatibility to a resin of base polymer itself is become higher due to a plasticity effect of a liquid flame retardant, and also is preferably dispersed to a resin is presumed compared to that of a base polymer which is not combined with liquid flame retardant is added to a resin. As a result, when a resin composition is produced by adding and kneading of particle of the present exemplary embodiment in a resin, it is inferred that the kneading property is excellent.

Further, as to the above, a liquid flame retardant is a compound which can give a flame retardant property to a resin molded article, while a base polymer is a compound which can give an impact resistance to a resin molded article. Accordingly, the resin molded article molded by adding a particle of the present exemplary embodiment to a resin obtains an excellent flame retardant property and an excellent impact resistance. Further since the particle of the present exemplary embodiment is preferably dispersed in a resin, it is inferred that variation of the impact resistance or the flame retardant property can be effectively inhibited.

Further, when a particle of the present exemplary embodiment is added to a resin, comparing to the addition of a base polymer which is not combined with a liquid flame retardant is added to a resin, it can be inhibited an immoderate strengthen of the plasticity effect. Therefore, it is inferred that the lowering of the moldability of a resin molded article due to an excessive lowering a viscosity of the resin composition can be effectively inhibited.

Here, as to the embodiment in which at least one selected from a liquid phosphate ester or an ionic liquid (liquid flame retardant) is combined with a base polymer, the following two embodiments may be specifically shown.

Surface Treatment

On the surface of the base polymer, a particle of at least one selected from a liquid phosphate ester or an ionic liquid (liquid flame retardant) is surface treated may exemplified.

By surface treatment of the surface of the base polymer using a liquid flame retardant, the surface of the base polymer of the composite particle is covered with the liquid flame retardant.

The surface treatment method of the liquid flame retardant to the surface of the base polymer is not specifically limited, however example includes the following method. For example, each of a base polymer and a liquid flame retardant are dry-blended and supplied from an origin feed opening of an extruder, and surface treatment is carried out by extruding to control the temperature and the number of rotations of a screw. For the extruder, a double axis extruder (for example, LABOPLASTMILL, trade name, manufactured by Toyo Seiki Co., Ltd., TEX SERIES, trade name, manufactured by JSW (The Japan Steel Works. Ltd.)), a single axis extender, etc., can be given.

In addition, surface treatment is carried out by adding a base polymer and a liquid flame retardant to a planetary ball mill, and controlling a treatment time to carry out mixing. As to a planetary ball mill, examples include PM SERIES (trade name, manufactured by Retch Inc.), PLANETARY MILL GALAXY SERIES (trade name, manufactured by Sansho Industry Co., Ltd.), and PLANETARY BALL MILL SERIES (trade name, manufactured by Fritsch Japan Co., Ltd.).

Impregnation

Example includes a particle in which at least one selected from the liquid phosphate ester or the ionic liquid (the liquid flame retardant) is impregnated into an interior part of the above base polymer.

Namely, the particle is in the state where the liquid flame retardant has penetrated and is included in the gaps of net structure of the base polymer.

The impregnation method of the liquid flame retardant into an inner part of base polymer is not specifically limited, however examples include the following method. For example, the base polymer and the liquid flame retardant are stirred and mixed in a container under vacuum to impregnate.

Hereinafter, each component of the particle of the present exemplary embodiment is described.

<Liquid Flame Retardant>

### Phosphate Ester

A phosphate ester used in the present exemplary embodiment is the compound represented by the following formula of chemical structure:

(RO)₃PO Formula:

[wherein, R represents an aliphatic group or an aromatic ring, and it can be the same or different, the aliphatic group can have a substituent such as OH group, and the aromatic ring can have a substituent such as OH group or an alkyl group.]

As to the specific example of the above phosphate ester, an aliphatic phosphate ester (for example, trimethyl phosphate, triethyl phosphate), an aromatic phosphate ester (for example, triphenyl phosphate), aromatic condensation phosphate ester, and so forth may be included.

Among them, in particular, an aromatic condensation phosphate ester is preferably used.

As to the specific example of the above aromatic condensation phosphate ester, for example, a pentaerythritol diphosphate or a phosphate ester compound represented by the following formula (I), (II) may be given:

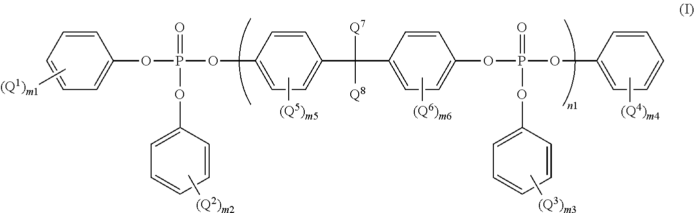

In the formula (I), each of Q¹, Q², Q³ and Q⁴ independently represents a hydrogen atom or an alkyl group having from 1 to 6 carbon atoms, each of Q⁵, Q⁶, Q⁷ and Q⁸ independently represents a hydrogen atom or a methyl group, each of m1, m2, m3 and m4 independently represents an integer from 0 to 3, each of m5 and m6 independently represents an integer from 0 to 2, and n1 represents an integer from 0 to 10.

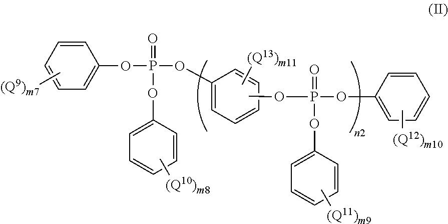

In the formula (II), each of Q⁹, Q¹⁰, Q¹¹ and Q¹² independently represents a hydrogen atom or an alkyl group having from 1 to 6 carbon atoms, Q¹³ represents a hydrogen atom or a methyl group, each of m7, m8, m9 and m10 independently represents an integer from 0 to 3, m11 represents an integer of from 0 to 4, n2 represents an integer from 0 to 10.

As to the present exemplary embodiment, for example, an aromatic condensation phosphate ester such as bisphenol A type, biphenylene type, isophthal type is suitably used. Further, as to an aromatic condensation phosphate ester, commercial product such as PX-200, PX-201, PX-202, CR-733 S, CR-741, CR747 (trade name, manufactured by Daihachi Chemical Industry Co., Ltd.) can be used.

Ionic Liquid

An ionic liquid used in a present exemplary embodiment is molten salt containing only of ions (anions and cations) which are liquid at 200° C. It has characteristics of non-vapour pressure (non-volatile), high heat-resistance, incombustibility, and chemical stability.

As to the cations, examples include cyclic amidine ions such as an imidazolium or organic cations such as pyridiniums, ammoniums, sulfoniums, and phosphoniums.

As to the anions which are combined with these cations, examples include as follows: Cl⁻, Br⁻, AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₂N⁻, (CF₃SO₂)₃C⁻, AsF₆⁻, SbF₆⁻F(HF)ₙ⁻, CF₃CF₂CF₂CF₂SO₃⁻, (CF₃CF₂SO₂)₂N⁻, CF₃CF₂CF₂COO⁻, CH₃COO⁻CH₃SO₄⁻, SCN⁻, CH₃CH₂SO₄⁻, HOSO₄⁻¹, H₃CO₃⁻.

<Base Polymer>

As to the above base polymer functioning as an impact resistant modifier, for example, a polyorgano siloxane rubber, a polyalkyl(meth)acrylate rubber, a poly butadiene rubber, a composite rubber of a polyorgano siloxane rubber and a polyalkyl(meth)acrylate rubber, and a graft copolymer which is graft polymerized them with a monomer having an ethylenic unsaturated bond, and so forth may be exemplified. In addition, examples include a three-dimensional cross-linked polymer, a polysaccharide of poor solubility, and a polymer compound having a porous structure.

Polyorgano Siloxane Rubber

As to the above polyorgano siloxane rubber, examples include polydialkyl siloxane such as poly dimethyl siloxane, polydiethyl siloxane, polydipropyl siloxane, polydibutyl siloxane, polydipentyl siloxane, and so forth.

Among them polydialkyl siloxane is preferable. Further, the preferable carbon number of 2 alkyl parts of the dialkylsiloxane is each independently from 1 to 6.

Poly Alkyl(meth)acrylate Rubber

As to the above poly alkyl(meth)acrylate rubber, examples include a poly alkyl (meth)acrylate such as a poly butyl acrylate, a poly methyl acrylate, poly ethyl acrylate, poly propyl acrylate, poly 2-ethyl hexyl acrylate.

The carbon numbers of the alkyl part of a poly alkyl (meth)acrylate are preferably from 1 to 6. In the present specification a “(meth)acrylate” represents an acrylate or methacrylate, and a “(meth) acrylic acid” represents an acrylic acid or methacrylic acid.

Composite Rubber

As to the composite rubber, rubber can be exemplified in which the polyorgano siloxane rubber described above is combined with the poly alkyl(meth)acrylate rubber described above. Further, the above polyorgano siloxane rubber component may be only 1 kind and may also be 2 or more kinds. Similarly, the above poly alkyl(meth)acrylate rubber component may be only 1 kind and also may be 2 or more kinds.

Further, for the above composite rubber, the content of the above polyorgano siloxane rubber component is preferably from 5% by weight to 80% by weight, more preferably from 5% by weight to 50% by weight.

Graft Copolymer

With regard to graft copolymer in which a polyorgano siloxane rubber or the above poly alkyl(meth)acrylate rubber is graft polymerized with a monomer having an ethylenic unsaturated bond for the above composite rubber, the monomer having an ethylenic unsaturated bond is for example an aromatic alkenyl compound such as styrene, α-methyl styrene, vinyl toluene, and so forth, a methacrylic ester such as methyl methacrylate, ethyl methacrylate, 2-ethyl hexyl methacrylate, and so forth, an acrylic ester such as methyl acrylate, ethyl acrylate, butyl acrylate, and so forth, a vinyl cyanide compound such as acrylonitrile, methacrylonitrile, and so forth. Among them, methacrylic ester, acrylic ester, acrylonitrile, methacrylonitrile, and styrene are preferred. Further, the preferable carbon numbers of an alkyl part of the above methacrylic ester and acrylic ester are each independently from 1 to 6.

The monomer having the above ethylenic unsaturated bond may be only one kind and also may be two or more kinds.

The above graft copolymer can be produced according to a conventional method without particular limitation. For example, when the monomer having an ethylenic unsaturated bond is graft-polymerized to the core of the above composite rubber to produce a graft copolymer having core-shell structure which forms as a shell, it can be produced as follows.

A mixture solution including a poly alkyl(meth)acrylate component is added to a latex of a polyorganosiloxane component, then the mixture solution is subjected to radical polymerization reaction. By doing this, the composite rubber component (core) is obtained. Next, the mixture solution including the above monomer having an ethylenic unsaturated bond is added all at once or drop wise to this composite rubber component. Then the composite rubber component is subjected to a graft-polymerization to obtain a graft copolymer by forming a shell.

Further, as to the above graft copolymer, a commercial product can be used. Examples include “EXL2603”, “KM-330” (trade name, manufactured by Rohm and Haas Company), “MR-01”, “MR-02” (trade name, manufactured by Kaneka Corp.), “METABRENE S-2001”, “S-2006, “S-2030”, “S-2100”, “SRK-200”, “SX-006”, “SX-005”, “W-300A”, “WL-450A”, “W-341”, “E-901”, “C-223A”, “C-323A”, “C-215A”, “C-201A”, “C-202”, “C-102”, “C-140A”, “C-132”, “F-410”, “H-602” (trade name, all are manufactured by Mitsubishi Rayon Co., Ltd.), and so forth.

Three-Dimensional Cross-Linked Polymer

As to a polymer compound having three-dimensional cross-linked polymer, example includes a (co)polymer containing one or two or more monomers and a cross-linking agent. The above monomer is represented by the following formula (1).

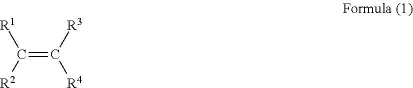

[R¹, R², R³, and R⁴ of the above formula (1) represent a hydrogen atom or an monovalent organic group. Further, all of R¹, R², R³, and R⁴ can have the same structure or different structure.]

For the above formula (1), from the viewpoint of easily obtaining a polymer compound by addition polymerization, especially, among R¹, R², R³, and R⁴, at least two are preferably hydrogen atoms. Further, in the case of the structure other than hydrogen atoms, it is preferable that R¹, R², R³ and R⁴ other than hydrogen atoms bond the same carbon atom.

As to the monomer, having the above formula (1), examples include ethylene, propylene, vinylidene fluoride, tetra fluoro ethylene, acryl amides such as acryl amide, N-isopropyl acryl amide, N,N-dimethyl acryl amide, N,N-dimethyl methacryl amide, N,N-diethyl acryl amide, N-tert-butyl acryl amide, N-tert-butyl methacryl amide, N-dodecyl acryl amide, N-hydroxy ethyl acryl amide, N,N-dimethyl amino propyl acryl amide, acrylolymorpholin, and so forth, vinyl amides such as N-vinyl acetamide and so forth, aryl amines such as N,N-diethyl aryl amine and so forth, aliphatic unsaturated hydrocarbons such as 2,4-dimethyl-1-pentin, 5-methyl-1-hexene, 1-hexene, 1-actin, 1-decene, 1-hexadecene, 1-octadecene and so forth, unsaturated hydrocarbons having aromatics as side chains such as styrene, 1,1-diphenyl ethylene, benzyl methacrylate, and so forth, vinyl esters such as vinyl n-butyrate, vinyl caprate, vinyl hexanate, vinyl octanate, vinyl laurate, vinyl stearate, vinyl pivalate, vinyl benzoate and so forth, methyl acrylate, methyl methacrylate, ethyl acrylate, ethyl methacrylate, n-butyl acrylate, n-butyl methacrylate, isobutyl acrylate, isobutyl methacrylate, hexyl acrylate, hexyl methacrylate, 2-ethyl hexyl acrylate, 2-ethyl hexyl methacrylate, 2-hydroxy ethyl methacrylate, 2-hydroxy propyl methacrylate, 2-hydroxy-1-methyl ethyl methacrylate, N,N-dimethyl amino ethyl acrylate, octadecylacrylate, octadecylmethacrylate, and so forth. They may be used singly or two or more may be mixed.

Further as to the cross-linking agent, examples include N,N′-methylenebisacrylamide (MBAAm) or ethyleneglycol dimethacrylate (EDMA), and so forth. As to the initiator, azobis isobutyronitrile (AIBN) or benzoyl peroxide (BPO), persulfate, and so forth.

Polysaccharide of Poor Solubility

As to the polysaccharide of poor solubility, examples include cellulose, cellulose fiber, cellulose powder, chitin, chitosan, and so forth. Specific examples include CELLULOSE FINE PARTICLE, trade name, manufactured by Asahi Kasei Fibers Corp., or VIVAPUR, VITACEL, ARBOCEL, trade name, manufactured by To a Kasei Co., Ltd., and so forth.

Polymer Compound Having Porous Structure

As to the polymer compound having porous structure, a general-purpose membrane or film which has been made porous without cross-linking the aforementioned cross-linked polymer by a cross-linking agent can be used. Specifically, examples include POAPRON MEMBRANE (PTFE) (trade name, manufactured by Sumitomo Electric Fine Polymer Inc.), TEMISH SERIES (trade name, manufactured by Nitto. Denko Corp.), DAIA RAMI (trade name, manufactured by Mitsubishi Plastics), DATA FOIL (trade name, manufactured by Mitsubishi Resin Inc.), NICHIGO POLYESTER, (trade name, manufactured by Nippon Synthetic Chemical Industry Co., Ltd.), KYNAR (trade name, manufactured by Arkema Co.), KYNAR FLEX (trade name, manufactured by Arkema Co.), PVDF MEMBRANE (trade name, manufactured by Westran) and so forth.

As to the particle according to the present exemplary embodiment, the content ratio (weight ratio) of the above liquid flame retardant (liquid phosphate ester, ionic liquid) to the base polymer is preferably 1:10 to 100:1 (or about 1:10 to about 100:1), more preferably 1:9 to 99:1. Further in the case of combination by the above method of “surface treatment”, the content ratio (weight ratio) of the liquid flame retardant to base polymer is preferably 1:2 to 1:10. In the case of combination by the above method of “impregnation”, the content ratio (weight ratio) of the liquid flame retardant to the base polymer is preferably 10:1 to 1:10.

<<Resin Composition>>

The resin composition according to the present exemplary embodiment, is characterized in that the particle according to the present exemplary embodiment is mixed and dispersed in the resin.

Further, as to the resin composition according to the present exemplary embodiment, the content of the particle is preferably from 1% by weight to 50% by weight (or from about 1% by weight to about 50% by weight) more preferably from 10% by weight to 30% by weight.

<Resin>

The resin (commonly called the matrix resin) of the resin composition according to the present exemplary embodiment can be exemplified as a thermoplastic resin.

Thermoplastic Resin

As to the above thermoplastic resin, a conventional resin is used. Specifically, polylactic acid resin, polycarbonate resin, polyester resin, polyester carbonate resin, polyphenylene ether resin, polyphenylene sulfide resin, polysulfon resin, poly ether sulfon resin, poly arylene resin, polyamide resin, polyetherimide resin, polyacetal resin, polyvinyl acetal resin, poly ketone resin, poly ether ketone resin, poly ether ether ketone resin, poly aryl ketone resin, poly ether nitrile resin, liquid crystal resin, poly benzo imidazole resin, poly paravan acid resin, vinyl polymer or copolymer resin obtained by polymerizing or copolymerizing at least one vinyl monomer selected from the group containing aromatic alkenyl compound, methacrylic ester, acrylic ester or vinyl cyanide compound, diene aromatic alkenyl compound copolymer resin, vinyl diene cyanide aromatic alkenyl compound copolymer resin, aromatic alkenyl compound-dienevinyl cyanide-N-phenylmaleimide copolymer resin, vinyl cyanide-(ethylenedienepropylene (EPDM))-aromatic alkenyl compound copolymer resin, polyolefin, vinyl chloride resin, chlorinated vinyl chloride resin can be exemplified. Among them, polycarbonate resin or polylactic acid resin is preferable.

Here, as to the polycarbonate (hereinafter, also called “PC”) resin, examples include an aromatic polycarbonate, a polyorganosiloxane containing aromatic polycarbonate, an aliphatic polycarbonate, an alicyclic polycarbonate, and so forth. Among them, an aromatic polycarbonate is preferable.

Further, the above polycarbonates resin may be used as an alloy resin in which at least one polycarbonates resin is combined with at least one styrene resin.

As to the styrenes resin, examples include GPPS resin(general polystyrene resin) HIPS resin(impact resistance polystyrene), SBR resin(styrene butadiene rubber) ABS resin(acrylonitrile-butadiene rubber-styrene copolymer) AES resin(acrylonitrile ethylenepropylene rubber styrene copolymer), AAS resin(acrylonitrile-acrylic rubber-styrene copolymer), MBS resin(methyl methacrylate-butadiene rubber-styrene copolymer), AS resin(acrylonitrile-styrene copolymer) MS resin(methyl methacrylate-styrene copolymer), and so forth. Among them, HIPS resin, ABS resin, AS resin, and so forth are preferable.

As to the commercial product of polycarbonate/styrenes alloy resin, “TN7300” of PC/ABS alloy resin (trade name, manufactured by Teijin Chemicals Ltd.), “NN2710AS” of PC/HIPS alloy resin (trade name, manufactured by Idemitsu Kosan Co., Ltd.), “ZFJ61” of PC/ABS alloy resin (trade name, manufactured by UMGABS), “C6600” of PC/ABS alloy resin, (trade name, manufactured by SABIC), and so forth can be exemplified.

Biodegradable Resin

Among the above thermoplastic resin, a biodegradable resin is suitably used. The biodegradable resin can be any resin having biodegradability, and it can be used polylactic acid, poly hydroxy butyrate, polycaprolactone, poly butyrene succinate, poly(butyrene succinate/adipate) poly(butyrene succinate/carbonate), polyethylene succinate, polyvinyl alcohol, cellulose acetate, starch modifying resin, cellulose modifying resin, and so forth. Among them, one selected from a polylactic acid, a copolymer of 3-hydroxy butyric acid and 3-hydroxyvaleric acid, or polybutyrene succinate is preferable. Further polylactic acid is more preferable.

The content of the above resin(matrix resin) in the resin composition according to the present exemplary embodiment is preferably from 50% by weight to 99% based on the total resin composition.

<Other Component>

The resin composition according to the present exemplary embodiment, can additionally include an other component. The content of the other component in the resin composition is preferably from 0% by weight to 10% by weight, more preferably from 0% by weight to 5% by weight. Here, “0% by weight” means that the other component is not included.

As to the other component, for example, various pigments, a modifier, a drip inhibitor, a compatibilizer, an antistatic agent, an antioxidant, a weather proofer, a resistance to hydrolysis inhibitor, a filler, a reinforcing agent (glass fiber, carbon fiber, talc, clay, mica, glass flake, milled glass, glass beads, crystalline silica, alumina, silicon nitride, alumina nitride, boron nitride, and so forth), and so forth can be exemplified. Further, the resin composition according to the present exemplary embodiment can include a polytetrafluoroethylene (PTFE) as the other component, for example from 0.1% by weight to 1% by weight.

<Method for Producing a Resin Composition>

The resin composition according to the present exemplary embodiment, at least, can be produced by adding a particle according to the above described present exemplary embodiment to the above resin, and further, for example, melt-kneading using other component to melt-kneading.

Here, as the units for melt-kneading, a known units can be used. Examples include a double axis extruder, Henshall mixer, Banbury mixer, single screw extruder, multi axis screw extruder, cokneader, and so forth.

<<Resin Molded Article>>

The resin molded article according to the present exemplary embodiment can be obtained by molding a resin composition related to the above described resin composition according to the present exemplary embodiment. For example, by a molding method such as an injection molding, an extrusion molding, a blow molding, a thermal press molding, a calender molding, a coating molding, a cast molding, a dipping molding, a vacuum molding, a transfer molding, and so forth, the resin composition according to the present exemplary embodiment is molded to obtain the resin molded article according to the present exemplary embodiment.

The injection molding can be carried out using a commercial device, such as for example, NEX150 (trade name, manufactured by Nissei Plastic Indusrial Co., Ltd.), NEX70000 (trade name, manufactured by Nissei Plastic Indusrial Co., Ltd.), SE50D (trade name, manufactured by Toshiba Machine Co., Ltd.), and so forth.

At this point, the cylinder temperature is preferably from 170° C. to 280° C., more preferably from 180° C. to 270° C. Further, the mold temperature is preferably from 40° C. to 110° C., more preferably from 50° C. to 110° C.

The resin molded article according to the present exemplary embodiment is suitably used as an electronic and an electric instrument, an electric home appliances, a container, or an automotive interiors. More specifically, in the case of electric home appliances or electronic and electric instrument, etc., various parts, etc., wrapping film, storage cases of CD-ROM or DVD, etc., tableware, food tray, beverage bottles, drug wrapping material, and so forth. Among them, it is suitable as the component of an electronic and an electric instrument.

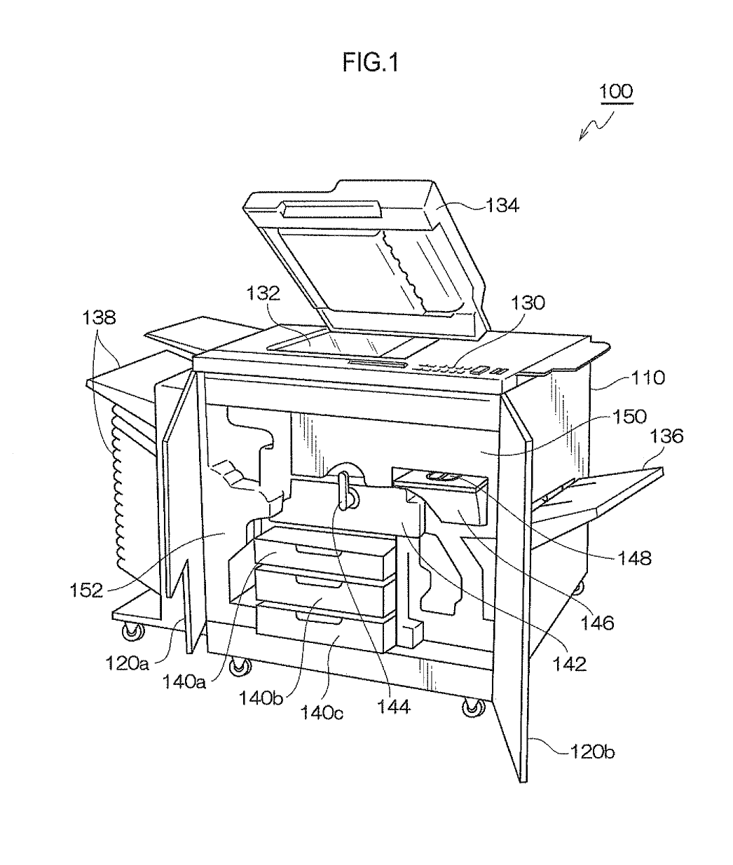

FIG. 1 is an external perspective view showed in front of an image forming apparatus of one example of the component of an electronic and an electric instrument having the molded article according to the present exemplary embodiment.

In the image forming apparatus 100 of FIG. 1, in front of the main body apparatus 110, the front covers 120a and 120b are equipped. These front covers 120a and 120b are freely opened and closed in order that an operator can operate an inner section of an apparatus. By doing this, an operator can supplement a toner when a toner is used up, or exchange a consumed process cartridge, or remove a paper when a paper jam occurs in the apparatus. FIG. 1 shows the apparatus in the state where the front cover 120a and 120b are opened.

In the surface of the main body apparatus 110, the operating panel 130 in which all of the conditions related to an image forming such as paper size, number of copies, and so forth are input by the operation of an operator, and, the copy glass 132 on which the document for reading is arranged, are provided. Also, upper section of the main body apparatus 110 is equipped with the auto document transferring apparatus 134 on the copy glass 132 by which the document is transferred. Further, the main body apparatus 110 is equipped with an image reading apparatus in which a document image arranged on the copy glass 132 is scanned and an image data showing a document image is obtained. The image data obtained by the image reading apparatus is sent to the image forming unit through a control section. Further, the image reading apparatus and the control section are accommodated at the inner section of housing 150 which constitutes a portion of the main body apparatus 110. Also, the image forming unit is the process cartridge 142 which is freely attached to or detached from the housing 150. The attaching and detaching of the process cartridge 142 is carried out by rotating the operation lever 144.

In the housing 150 of main body apparatus 110, the toner containing section 146 is equipped, and from the toner feed opening 148, the toner is supplied. The toner contained in the toner containing section 146 is to be fed to an image apparatus.

Meanwhile, in the lower section of the main body apparatus 110, the paper containing cassettes 140a, 140b, 140c are equipped. Further, in the main body apparatus 110, plural transfer rollers including a pair of rollers are arranged in the apparatus. By doing this, the transfer route, by which paper of a paper containing cassette is transferred to an image forming unit located in the upper section, is formed. Further, the paper of each paper containing cassette is taken-out one by one by a paper taking out mechanism arranged in the vicinity of the end section of the transfer route to be conveyed to the transfer route. Also, at a side face of the main body apparatus 110, the manual paper supply section 136 is equipped, and the paper is also supplied therefrom.

The paper on which an image is formed by the image forming unit, is sequentially transported between two fixing rolls contacting each other which are supported by the housing 152 constituting a part of the main body apparatus 110. After that, the paper is ejected to the exterior of the main body apparatus 110. In the main body apparatus 110, plural paper ejection sections 138 are equipped at the opposite side to the side where the paper supply section 136 is provided. The paper upon which image forming has been completed is ejected at the paper ejection section.

With regard to the image forming apparatus 100, for example, the front cover 120 a, 120 b, the exterior of the process cartridge 142, the housing 150, and the housing 152 use the resin molded article according to the present exemplary embodiment.

### Examples

Hereinafter, the invention will be described in more detail based on Examples, but the invention is not limited to the following Examples.

[Preparation of Surface Treated Particle (A-1)]

Condensation phosphate ester (1,3-phenylenebis(di-2,6-xylenyl phosphate), liquid flame retardant, PX-200, trade name, manufactured by Daihachi Chemical Industry Co., Ltd.).

Base polymer (acrylonitrile-styrene-alkyl acrylate-dimethyl siloxane copolymer (polymerization ratio 10:20:50:20 (weight ratio), an impact resistance modifier, SRK200, trade name, manufactured by Mitsubishi Rayon Co., Ltd.).

Using a double axis extruder (LABO PLASTMILL, trade name, manufactured by Toyo Seiki Co., Ltd., φ25 mm), the ratio of 1:4 (weight ratio) of the above condensation phosphate ester to base polymer is dry blended, and from the origin feed opening of the above extruder is fed under the condition of 110° C. of barrel temperature and propeller rotations of 30 rpm, the extrusion is carried out. The “base polymer composite which is surface treated with the liquid flame retardant” ejected from the front end of the extruder, is cut into a pellet shape. By doing this the particle (A-1) is obtained.

[Preparation of Surface Treated Particle (A-2)]

With regard to the preparation of a particle (A-1), the particle (A-2) is obtained by the same method, except that the ratio of the condensation phosphate ester to base polymer is changed to 1:2 (weight ratio).

[Preparation of Impregnated Particle (B-1)]

Ionic liquid (chemical name: 1-butyl-3-methyl imidazolium methan sulphonate, liquid flame retardant, Sigma-Aldrich Co.)

Base polymer (poly vinylidene fluoride, Westran PVDF membrane (pulverized))

The above ionic liquid and the base polymer are stirred and mixed in the ratio of 1:1 (weight ratio) in the container under the vacuum state to impregnate the ionic liquid into the base polymer. By doing this particle (B-1) is obtained.

[Preparation of Impregnated Particle (B-2)]

Condensation phosphate ester (1,3-phenylene bis(di-2,6-xylenyl phosphate), a liquid flame retardant, PX-200, trade name, manufactured by Daihachi Chemical Industry Co., Ltd.)

Base polymer (acrylonitrile-styrene-alkyl acrylate-dimethyl siloxane copolymer (polymerization ratio 10:20:50:20 (weight ratio), an impact resistance modifier, SRK200, trade name, manufactured by Mitsubishi Rayon Co., Ltd.)

The above condensation phosphate ester and the base polymer are stirred and mixed in the ratio of 1:2 (weight ratio) in the container under the vacuum state to impregnate the condensation phosphate ester into the base polymer. By doing this particle (B-2) is obtained.

(Preparation of the Resin Composition and Resin Molded Article)

In the Examples, the particle obtained above is used, and by the composition ratio described in Table 1, the resin composition is prepared and the resin molded article is molded as in the following method.

Further, in the comparative examples, by the composition ratio described in Table 1, the resin composition is prepared and the resin molded article is molded as in the following method.

—Method of Preparation of the Resin Composition and Resin Molded Article—

Using a double axis extruder (LABO PLASTMILL, trade name, manufactured by Toyo Seiki Co., Ltd., φ25 mm), dry blended material shown in the following Table 1 is fed from the origin feed opening of the extruder, and the cylinder temperature is set to that described in Table 1, and under the conditions of propeller rotations of 30 rpm, the extrusion is carried out. The fused resin ejected from the front end of the extruder, is cooled in the cooling water, cut a solidifying composition into a pellet shape. By doing this resin composition is obtained.

The obtained resin composition is dried at 80° C. for 4 hours or more. Then it carries out an injection molding is carried out in the NEX50 (trade name, manufactured by Nissei Plastic Indusrial Co., Ltd.), at the cylinder temperature described in Table 1 to prepare a multipurpose test piece established by JIS-K7139 (the year 2007) and a test piece established by UL94 5^{th} edition (it includes the amendment up to Jun. 2, 2006) section 8.3.

—Evaluation—

### (1) Impact Resistance

According to ISO179, Charpy impact-resistance strength is measured in the impact resistant test apparatus (DG-5, trade name, manufactured by Toyo Seiki Co., Ltd.). The degree of variation is evaluated according to the following criteria from the difference between the upper limit and lower limit when the 50 numbers of test pieces are measured.

A: The difference between the upper limit and lower limit is 1 or less
C: The difference between the upper limit and lower limit is more than 1

### (2) Flame Retardant Property

According to the evaluation criteria established by UL94 5^{th} edition (it includes the amendment up to Jun. 2, 2006), the flame retardant property is evaluated using a test piece of 1.6 mm thickness. The level of flame retardant property is lowered in the order of V-0>V-1>V-2>not V. If the level is at least V-2, it can be said that it has good flame retardant property.

Further, the degree of variation is evaluated according to the following criteria from the difference between the upper limit and lower limit of total ignition time when 50 numbers of test pieces are measured.

A: The difference between the upper limit and lower limit is 20 or less
C: The difference between the upper limit and lower limit is more than 20

### (3) Processability/Kneading Property

In the double axis extruder (LABO PLASTMILL, trade name, Toyo Seiki Co., Ltd., φ25 mm), the resin composition (resin pellet) obtained above is dry blended, and fed from the rigin feed opening of the extruder, and under the conditions of the set up cylinder temperature set as shown in Table 1 and propeller rotations of 70 rpm, the extrusion is carried out. At this point, the discharge volume is measured for the region of not over the torque limit (the range of not over 100 N·m). Then it is evaluated according to the following criteria.

A: The discharge volume is 1.5 kg or more
C: The discharge volume is less than 1.5 kg

### (4) Processability/Flowability

According to JISK 7210 (the year 2007), the resin pellet dried at 80° C. for 4 hours or more is measured a MVR (Model F-F01, trade name, manufactured by Toyo Seiki Co., Ltd.). The higher the value, more high flowability, and excellent molding processability are represented. Further, PBS, PLA is measured under the conditions of 190° C./2.16 kg, and PC/ABS is measured under the condition of 250° C./2.16 kg. Each of them is evaluated according to the following criteria.

A: MVR is from 10 cm³/10 min to 25 cm³/10 min.
C: MVR is less than 10 cm³/10 min, or more than 25 cm³/10 min.

TABLE 1

| | composition (part by weight) | | | | | | | | | | | Kneading |
|---|---|---|---|---|---|---|---|---|---|---|---|---|
| | | | | particle | | | | flame retardant | | base polymer | | condition |
| | | | | (surface | | particle | | condensation | | base | base | cylinder |
| | resin | | | treatment) | | (impregnation) | | phosphate | ionic | polymer | polymer | temperature |
| | PBS | PC/ABS | PLA | A-1 | A-2 | B-1 | B-2 | ester | liquid | a | b | [° C.] |
| Example A- | 100 | | | 5 | | | | | | | | 180 |
| 1 | | | | | | | | | | | | |
| Example A- | 100 | | | 10 | | | | | | | | 180 |
| 2 | | | | | | | | | | | | |
| Example A- | 100 | | | | | 8 | | | | | | 180 |
| 3 | | | | | | | | | | | | |
| Example A- | | 100 | | | 3 | | | | | | | 240 |
| 4 | | | | | | | | | | | | |
| Example A- | | 100 | | | 7 | | | | | | | 240 |
| 5 | | | | | | | | | | | | |
| Example A- | | 100 | | | | | 5 | | | | | 240 |
| 6 | | | | | | | | | | | | |
| Example A- | 100 | | | 15 | | | | 7 | | | | 180 |
| 7 | | | | | | | | | | | | |
| Example A- | | 100 | | | | 12 | | 3 | | | | 240 |
| 8 | | | | | | | | | | | | |
| Comparative | 100 | | | | | | | 3 | | 7 | | 180 |
| Example A- | | | | | | | | | | | | |
| 1 | | | | | | | | | | | | |
| Comparative | | 100 | | | | | | 2 | | 5 | | 240 |
| Example A- | | | | | | | | | | | | |
| 2 | | | | | | | | | | | | |
| Example B- | | | 100 | 5 | | | | | | | | 180 |
| 1 | | | | | | | | | | | | |
| Example B- | | | 100 | 10 | | | | | | | | 180 |
| 2 | | | | | | | | | | | | |
| Example B- | | | 100 | 10 | | | | 10 | | | | 180 |
| 3 | | | | | | | | | | | | |
| Example B- | | | 100 | | 5 | | | 10 | | | | 180 |
| 4 | | | | | | | | | | | | |
| Example B- | | | 100 | | 7 | | | 7 | | | | 180 |
| 5 | | | | | | | | | | | | |
| Comparative | | | 100 | | | | | 20 | | 3 | | 180 |
| Example B- | | | | | | | | | | | | |
| 1 | | | | | | | | | | | | |
| Comparative | | | 100 | | | | | 20 | | 10 | | 180 |
| Example B- | | | | | | | | | | | | |
| 2 | | | | | | | | | | | | |
| Example C- | | | 100 | | | 5 | | 10 | | | | 180 |
| 1 | | | | | | | | | | | | |
| Example C- | | | 100 | | | 7 | | 7 | | | | 180 |
| 2 | | | | | | | | | | | | |
| Example C- | | | 100 | | | | 5 | 10 | | | | 180 |
| 3 | | | | | | | | | | | | |
| Example C- | | | 100 | | | | 7 | 7 | | | | 180 |
| 4 | | | | | | | | | | | | |
| Comparative | | | 100 | | | | | 10 | 2 | | 5 | 180 |
| Example C- | | | | | | | | | | | | |
| 1 | | | | | | | | | | | | |
| Comparative | | | 100 | | | | | 10 | 4 | | 5 | 180 |
| Example C- | | | | | | | | | | | | |
| 2 | | | | | | | | | | | | |

Further, each compound listed in the above Table 1 is the same as follows:
PBS: polybutyrene succinate, BIONOLLE (trade name, manufactured by Showa Highpolymer Co., Ltd.)
PC/ABS: Alloy resin of a polycarbonate and acrylonitrile-butadiene rubber-styrene copolymer, C6600 (trade name, manufactured by SABIC)
PLA: polylactic acid, TERRAMAC TE 4000 (trade name, manufactured by Unitika Ltd.)
Condensation phosphate ester: 1,3-phenylenebis(di-2,6-xylenyl phosphate), PX-200 (trade name, manufactured by Daihachi Chemical Industry Co., Ltd.)
Ionic liquid: 1-butyl-3-methylimidazolium methane, Sigma-Aldrich Co.
Base polymer a: SRK 200 (trade name, manufactured by Mitsubishi Rayon Co., Ltd.)
Base polymer b: WESTRAN PVDF MEMBRANE (pulverized)

TABLE 2

| | | | Variation | | |
|---|---|---|---|---|---|
| | Variation | Flame | of flame | | |
| | of impact | retardant | retardant | Kneading | Flow- |
| | resistance | property | property | property | ability |
| Example A-1 | A | V-2 | A | A | A |
| Example A-2 | A | V-2 | A | A | A |
| Example A-3 | A | V-2 | A | A | A |
| Example A-4 | A | V-1 | A | A | A |
| Example A-5 | A | V-1 | A | A | A |
| Example A-6 | A | V-1 | A | A | A |
| Example A-7 | A | V-0 | A | A | A |
| Example A-8 | A | V-0 | A | A | A |
| Comparative | C | not V | C | C | A |
| Example A-1 | | | | | |
| Comparative | C | not V | C | C | A |
| Example A-2 | | | | | |
| Example B-1 | A | V-2 | A | A | A |
| Example B-2 | A | V-2 | A | A | A |
| Example B-3 | A | V-0 | A | A | A |
| Example B-4 | A | V-0 | A | A | A |
| Example B-5 | A | V-0 | A | A | A |
| Comparative | C | not V | C | C | C |
| Example B-1 | | | | | |
| Comparative | C | not V | C | C | C |
| Example B-2 | | | | | |
| Example C-1 | A | V-0 | A | A | A |
| Example C-2 | A | V-0 | A | A | A |
| Example C-3 | A | V-0 | A | A | A |
| Example C-4 | A | V-0 | A | A | A |
| Comparative | C | not V | C | C | C |
| Example C-1 | | | | | |
| Comparative | C | not V | C | C | C |
| Example C-2 | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A particle comprising:
at least one selected from,
an ionic liquid that has, as an organic cation, one selected from cyclic amidine ion-based organic cations, pyridinium-based organic cations, ammonium-based organic cations, sulfonium-based organic cations, and phosphonium-based organic cations, or
a liquid phosphate ester; and
a polymer compound that serves as a base material selected from the group consisting of a rubber, a three-dimensional cross-linked polymer, and a polysaccharide having poor solubility.

2. The particle according to claim 1, wherein the at least one selected from the liquid phosphate ester or the ionic liquid is present on the surface of the polymer compound that serves as a base material.

3. The particle according to claim 1, wherein the at least one selected from the liquid phosphate ester or the ionic liquid is present in the interior of the polymer compound that serves as a base material.

4. The particle according to claim 1, wherein the phosphate ester is a compound that has a chemical structure represented by the following formula:
(RO)₃PO formula:
wherein, in the formula, R represents an aliphatic group or an aromatic ring,
each R may be the same or different from each other, the aliphatic group may have a substituent, and the aromatic ring may have a substituent.

5. The particle according to claim 4, wherein the substituent of the aliphatic group is an OH group.

6. The particle according to claim 4, wherein the substituent of the aromatic ring is an OH group or an alkyl group.

7. The particle according to claim 1, wherein the phosphate ester is one selected from the group consisting of an aliphatic phosphate ester, an aromatic phosphate ester, and an aromatic condensation phosphate ester.

8. The particle according to claim 7, wherein the aromatic condensation phosphate ester is pentaerythritol diphosphate or an aromatic condensation phosphate ester represented by the following formula (I) or (II): 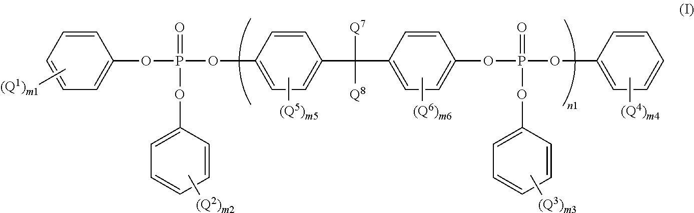
wherein, in the formula (I), Q¹, Q², Q³ and Q⁴ each independently represent a hydrogen atom or an alkyl group having from 1 to 6 carbon atoms;
Q⁵, Q⁶, Q⁷ and Q⁸ each independently represent a hydrogen atom or a methyl group;
m1, m2, m3 and m4 each independently represent an integer from 0 to 3;
m5 and m6 each independently represent an integer from 0 to 2; and
n1 represents an integer from 0 to 10, 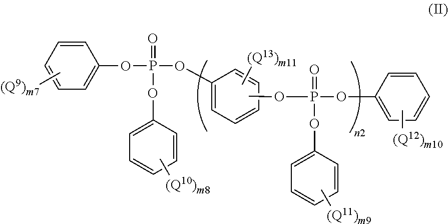
wherein, in the formula (II), Q⁹, Q¹⁰, Q¹¹ and Q¹² each independently represent a hydrogen atom or an alkyl group having from 1 to 6 carbon atoms;
Q¹³ represents a hydrogen atom or a methyl group;
m7, m8, m9 and m10 each independently represent an integer from 0 to 3;
m11 represents an integer from 0 to 4; and
n2 represents an integer from 0 to 10.

9. The particle according to claim 7, wherein the aromatic condensation phosphate ester comprises one structure selected from bisphenol-A or biphenylene.

10. (canceled)

11. The particle according to claim 1, wherein the content ratio of the at least one selected from the liquid phosphate ester or the ionic liquid to the polymer compound that serves as a base material is from about 1:10 to about 100:1.

12. A resin composition comprising the particle according to claim 1 that is mixed and dispersed in a resin.

13. The resin composition according to claim 12, wherein the resin is a thermoplastic resin.

14. The resin composition according to claim 12, wherein the content ratio of the particle is from about 1% by weight to about 50% by weight.

15. A resin molded article comprising the resin composition according to claim 12, wherein the resin composition is molded.

16. The resin molded article according to claim 15, wherein the resin molded article is a component of an electric or electronic apparatus.

17. The particle according to claim 1, wherein the polysaccharide having poor solubility is a polysaccharide selected from the group consisting of cellulose, cellulose fiver, cellulose powder, chitin and chitosan.

18. The particle according to claim 1, wherein the polymer compound that serves as a base material is a polymer compound having a porous structure.
